(19) United States
(12) Patent Application Publication
(10) Pub. No.: US 2026/0280419 A1
(43) Pub. Date: Sep. 17, 2026

(54) Reduced EMI Inverter Dead Time Compensator System and Method Thereof

(71) Applicant: The United States Navy, as Represented by the Secretary of the Navy, Arlington, VA (US)

(72) Inventors: Giovanna Oriti, Seaside, CA (US); Alexander Lloyd Julian, Seaside, CA (US)

(21) Appl. No.: 19/012,231

(22) Filed: Jan. 7, 2025

(51) Int. Cl. H02M 1/44; H02J 3/38; H02M 1/38; H02M 7/483; H02M 7/539

(52) U.S. Cl. CPC H02M 1/44; H02M 1/385; H02M 7/483; H02M 7/539

(57) ABSTRACT

A reduced common mode voltage inverter comprising: an energy source, the energy source being electrically coupled to multiple half-bridge circuits; each of the multiple half-bridge circuits having an output and each output being electrically coupled to one or more phase loads; a control circuit being electrically coupled to multiple transistors of each of the multiple half-bridge circuits; and a dead time compensator, the dead time compensator configured to delay commutation of the multiple half-bridge circuits.

### STATEMENT OF GOVERNMENT INTEREST

The present disclosure was made in the performance of official duties by one or more employees of the Department of the Navy, and thus, embodiments herein may be manufactured, used or licensed by or for the Government of the United States of America for governmental purposes without the payment of any royalties thereon or therefor.

### FIELD OF USE

The present disclosure relates, in general, to a system and method of reducing high frequency common mode electromagnetic interference of four-legged three phase inverters. More specifically, the present disclosure relates to a dead time compensator.

### BACKGROUND

Generally, four-legged inverters are used in three-phase applications where loads on each phase may not be equal, such as in a distributed power system. By controlling the dedicated neutral point current, four-legged three-phase inverters can maintain a balanced output voltage even when the load is unbalanced.

Four-legged inverters allow for better voltage regulation and power quality, especially in non-linear loads or microgrid applications having diverse power sources.

Typical four-legged inverters are implemented with semiconductor devices to switch a direct current (DC) source to create a sinusoidal output voltage waveform providing output power over all loading conditions and transients. When power semiconductor devices switch quickly, they can create conducted and radiated electromagnetic interference (EMI) from parasitic voltages and currents. Faster switching times in power electronics can lead to faster voltage and current signal rise and fall times, which produce more energy at high frequencies. These harmonics are the leading cause of EMI in four-legged inverters.

Parasitic voltages and currents are unwanted and unintended electrical voltages or currents in circuits due to unavoidable capacitances and inductances within a circuit design. Parasitic voltages and currents may be common mode voltages (CMV) or currents (CMI) occurring along the lines and components of a closed loop simultaneously, in the same direction, and in phase with respect to a common reference ground.

EMI is unwanted noise or interference in an electrical circuit or path caused by an external source. EMI is also known as radio frequency interference (RFI) in the radio frequency spectrum. EMI can be transmitted through radiated or conducted paths, or both, from one electronic device to another. EMI can be caused by inherent noise created within an electrical device by thermal agitation, such as electrons moving through a circuit resistor; natural EMI caused by natural events, such as lightning, electric storms, loud sounds, or the Earth's magnetic fields; human-made EMI produced by electronic equipment, such as cell phones, medical equipment, microwave ovens, and speakers, harmonic magnetic fields, and RF fields.

EMI is further classified into common mode (CM) and differential mode (DM) EMI. DM EMI is a conducted electromagnetic interference (EMI) noise between two conductors within a cable or on a printed circuit board (PCB) and is characterized by two signals 180 degrees out of phase and flowing in opposite directions on the wire. CM EMI occurs along the lines of a closed loop simultaneously, in the same direction and in phase current with respect to a common reference ground. It is usually caused by high-frequency currents flowing in the same direction down both interconnect lines and through the parasitic capacitance of diodes, transistors, and transformers to ground in a power circuit.

One method of reducing high-frequency CMV and thereby reducing CM EMI is by switching the semiconductor devices at a point where zero voltage or current flows through the semiconductor. This is called zero current switching or soft switching.

Zero current switching (ZCS) reduces EMI because it ensures that a power switch turns on or off when the current flowing through it is zero, resulting in a significantly lower rate of change of current (di/dt), which is the primary factor contributing to electromagnetic interference (EMI) generation in switching circuits; essentially, by eliminating the sudden current transitions, ZCS minimizes the electromagnetic noise produced during switching events.

Four-legged inverters typically use pulse density modulation (PDM) switching algorithms for lower noise and finer resolution, as PDM can switch more frequently, resulting in a smoother analog signal with less distortion. Additionally, to avoid a short circuit within the four-legged inverter a control circuit causes a dead time in commutation. A dead time period during commutation ensures that one switch turns off completely before the other turns on, thereby avoiding simultaneous conduction which could damage the device due to the switching components' finite turn-on and turn-off times.

Theoretically, ZCS should nearly eliminate CMV and CM EMI. Still, due to the need for a commutation dead time, the PDM ZCS (common mode voltage reduction) algorithm is interfered with, generating some CMV and CM EMI. The more frequent PDM switching produces higher frequency CMV components that are typically managed using additional hardware, such as bulky and heavy passive CM chokes or active filters requiring additional circuit and control hardware.

The additional hardware may not always allow an inverter to meet operational standards.

Insertion of commutation dead time to avoid a short circuit interferes with the CMV reduction algorithm, causing a remaining out-of-tolerance high-frequency common mode electromagnetic interference (CM EMI). Therefore, a method and system for reducing CMV is needed while allowing for a dead time in commutation.

The background section is provided to reveal information believed by the applicant to be of possible relevance to the present technology. No admission is necessarily intended, nor should be construed, that any of the preceding information constitutes prior art against the present technology.

### SUMMARY

To minimize the limitations in the prior art, and to minimize other limitations that will become apparent upon reading and understanding the present specification, the present disclosure discloses a new and useful system and method of reducing high frequency common mode electromagnetic interference of four-legged three phase inverters.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The problem with high-frequency common mode electromagnetic interference produced during the commutation of four-legged inverters is solved by varying a delay in commutation dead time.

A dead time compensator may be implemented in control circuits or an algorithm as part of an operational modulating signal that controls an inverter. Adding a delay to the commutation of one or more transistors of a half-bridge circuit may reduce CMV or EMI

One embodiment of the present disclosure may be a reduced common mode voltage inverter comprising: an energy source, the energy source being electrically coupled to multiple half-bridge circuits; each of the multiple half-bridge circuits having an output and each output being electrically coupled to one or more phase loads; a control circuit being electrically coupled to multiple transistors of each of the multiple half-bridge circuits; and a dead time compensator, the dead time compensator configured to delay commutation of the multiple half-bridge circuits.

Wherein a commutation dead time delay is equal to a dead time delay. Wherein a commutation dead time delay is between 0 nanoseconds (ns) to a maximum range based at least in part on a common mode voltage (CMV) tolerance and power output quality tolerance. The inverter further comprising multiple sensors; the multiple sensors being electrically coupled to the multiple transistors and the outputs of the multiple half-bridge circuits; wherein the multiple sensors are configured to measure current and voltage of the multiple half-bridge circuits and the outputs; wherein the control circuit determines whether an unbalanced change in a voltage or a current exists between any of the multiple half-bridge circuits; and wherein the control circuit determines whether to increase, decrease, or not adjust a dead time commutation delay. Wherein the dead time commutation delay is based at least in part on a current polarity and a status of the multiple transistors. Wherein the control circuit controls the multiple transistors by pulse density modulation. The inverter comprising four half-bridge circuits. The inverter comprising a four wire three phases output. Wherein the energy source is a direct current (DC) source, and the DC source is selected from the group of DC sources consisting of one or more of: a battery, a solar cell, a fuel cell, a thermal conversion device, and a biomass.

Another embodiment of the present disclose may be a micro-grid common mode voltage reducing four-legged three phase inverter comprising: a distributed energy source, the distributed energy source being electrically coupled to four half-bridge circuits; the four half-bridge circuits coupled to a four wire three phase output; a control circuit being electrically coupled to multiple transistors of the multiple half-bridge circuits, and controls the multiple transistors by pulse density modulation; and a dead time compensator, the dead time compensator configured to delay commutation of the multiple half-bridge circuits. The inverter further comprising multiple sensors; the sensor being electrically coupled to the multiple transistors and the three phase output; wherein the sensors are configured to measure current and voltage of the multiple half-bridge circuits and the each of the three phase outputs; wherein the control circuit determines whether an unbalanced change in a voltage or a current exists on any of the multiple half-bridge circuits; and wherein the control circuit determines whether to increase, decrease, or not adjust a dead time commutation delay. Wherein the dead time commutation delay is based at least in part on a current polarity and a status of the multiple transistors. Wherein the dead time commutation delay is zero nanoseconds. The inverter further comprising an LCL filter circuit at three of the half-bridge circuits and coupled to a four wire three phase output. Wherein the distributed energy source is a direct current (DC) source, and the DC source is selected from the group of DC sources consisting of one or more of: a battery, a solar cell, a fuel cells, a thermal conversion device, and a biomass.

Another embodiment of the present disclosure may be a method of reducing common mode EMI in a four-legged inverter, the method comprising: by a four-legged three phase inverter: providing a distributed energy source, wherein the distributed energy source is a direct current (DC) source; providing a DC current to four half-bridge circuits modulating the DC current, by a control circuit pulse density modulating (PDM) to generate an alternating current (AC) sinusoidal electrical power output; and dead time compensating, by a control circuit, wherein the control circuit delays the commutation of the four half-bridge circuits. Wherein the dead time commutation delay is 0 nanoseconds (ns), 200 ns, 250 ns, 300 ns, 350 ns, or 400 ns. Wherein a commutation dead time delay is between 0 nanoseconds (ns) to a maximum range based at least in part on a common mode voltage (CMV) tolerance and power output quality tolerance. The method further comprising: determining, by a control circuit, whether an unbalanced change in a voltage or a current exists on any of the multiple half-bridge circuits. The method further comprising: compensating, by a control circuit, a dead time commutation delay; wherein the control circuit determines whether to increase, decrease, or not adjust a dead time commutation delay; and wherein the dead time commutation delay is based at least in part on a current polarity and a status of the multiple transistors.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The drawings are of illustrative embodiments. They do not illustrate all embodiments.

Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a grid-connected three-phase, four-legged voltage source inverter.

FIG. 2 is a graph illustrating common mode voltage during commutation of a four-legged inverter without dead time compensation.

FIG. 3 is a graph illustrating common mode voltage during commutation of a four-legged inverter with dead time compensation.

FIG. 4 is a graph representing a four-legged inverter's measured common mode voltage with zero dead time compensation.

FIG. 5 is a graph representing the measured common mode voltage of a four-legged inverter having 100 ns of dead time compensation.

FIG. 6 is a spectral graph representing a four-legged inverter's measured common mode voltage with no additional dead time compensation.

FIG. 7 is a spectral graph representing the measured common mode voltage of a four-legged inverter having dead time compensation.

FIG. 8 is an illustration of one embodiment of a control system for a dead time compensator.

FIG. 9 is a process flow block diagram of one embodiment of a method of reducing EMI by controlling the dead time commutation in a four-legged inverter.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiment, an entirely software embodiment, or an embodiment combining software and hardware embodiments. Furthermore, the systems and methods may take the form of Non-transitory computer readable media. More particularly, the present methods and systems may take the form of web-implemented computer software or a computer program product. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Those skilled in the art will recognize many modifications may be made to this configuration without departing from the scope of the disclosed embodiments.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of the various embodiments of the device, method, and/or system. For example, as used herein, the terms “computer” and “computer system” generally refer to any device that processes information with an integrated circuit chip and/or central processing unit (CPU).

As used herein, the terms “software” and “application” refer to any set of machine-readable instructions on a machine, web interface, and/or computer system” that directs a computer's processor to perform specific steps, processes, or operations disclosed herein.

As used herein, the term “computer-readable medium” refers to any storage medium adapted to store data and/or instructions that are executable by a processor of a computer system.

The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

As used herein, the term “commutation” refers to the process of switching the current flow from one power electronic device to another power electronic device.

As used herein, the term “dead time” refers to a small intentional delay introduced between the turn-off signal of one power switching device and the turn-on signal of the other device in a half-bridge circuit.

As used herein, the term “driving” refers to actively controlling another circuit by providing the necessary voltage, current, or signal to power and or operate the target circuit.

As used herein, the term “leg” or “half-bridge inverter” refers to a single phase of an alternating current (AC) output, essentially representing one of the power switching circuits within an inverter that contributes to generating a complete AC waveform.

As used herein, the term “phase” refers to a single alternating current (AC) waveform within a system where three separate waveforms are present, each shifted 120 degrees apart in their electrical cycle.

Inverters typically require some delay in commutation between switches due to a potential state that may cause a short circuit that may damage power electronic devices. This delay is referred to as dead time. Insertion of dead time may lead to an unbalanced change in the output voltage that may produce common mode voltage (CMV) spikes that may result in electromagnetic interference (EMI). The amount of CMV or EMI may be reduced using a dead time compensator that may delay switching events or extend a transistor's “on” time.

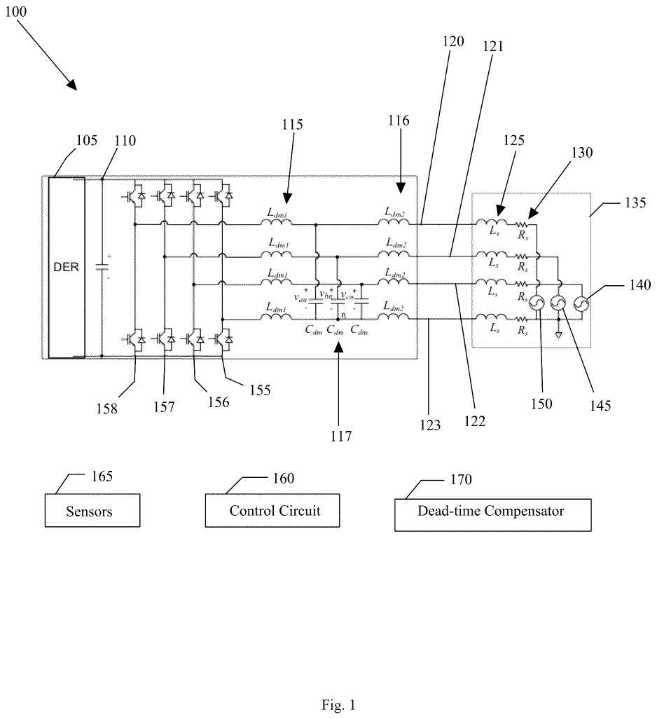

FIG. 1 is an illustration of one embodiment of a grid-connected three-phase, four-legged voltage source inverter. A grid-connected three-phase four-legged voltage source inverter 100 may include distributed energy resource (DER) 105, capacitor 110, multiple half-bridge circuits 155, 156, 157, and 158, inductors 115, 116, capacitors 117, phase outputs 120, 121, 122, and 123, and source inductance 125, source resistance 130, load 140, 145, and 145, control circuit 160, sensors 165, and dead time compensator 170.

DER 105 may be a smaller power generator or one or more energy storage units located remotely or installed on-site and connected to a local electric power grid or isolated in a microgrid. DER 105 may be used for but should not be limited to meeting goals and mandates, providing revenue streams, lowering the overall cost of a microgrid, and providing power during a grid outage. DER 105 may be small-scale technologies that generate and provide energy, improve reliability, and reduce costs. DER 105 may include but should not be limited to solar panels, wind turbines, storage systems, batteries, combined heat and power (CHP) systems, charging stations, grid-interactive buildings, and microgrids.

Capacitor 110 may filter differential mode EMI, filter ripple, smooth transients, and correct voltage lags.

Multiple half-bridge circuits 155, 156, 157, and 158 may comprise multiple transistors that may be switched on and off at a rate and pattern to produce a sinusoidal power waveform (not shown). The multiple transistors in half-bridge circuits 155, 156, 157, and 158 may be but should not be limited to bipolar junction transistors (BJTs), field-effect transistors (FETs), metal oxide semiconductor field-effect transistors (MOSFET), and insulated gate bipolar transistor (IGBTs). It is preferable that the transistors be able to switch at high speeds, be voltage controlled, have low conduction losses, and be easy to use. The transistors of half-bridge circuits 155, 156, 157, and 158 may be switched at speeds ranging from 50 kHz to 4 MHz. Switching speeds may be limited by electromagnetic interference (EMI) standards and tolerances.

Each half-bridge circuits 155, 156, 157, and 158 may include inductors 115, 116 and capacitors 117 configured to filter high-frequency components of voltage and current that may be generated through the operation of half-bridge circuits 155, 156, 157, and 158. Three half-bridge circuits 156, 157, and 158 may have phase outputs 120, 121, 122, and half-bridge circuits 155 phase output 123 may be connected to a neutral point of load 140, 145, and 145. half-bridge circuits 155 phase output 123 may allow for independent control of a neutral voltage for managing unbalanced loads or harmonic currents.

Source inductance 125 and or source resistance 130 may affect the quality of the output voltage waveform during rapid current changes, as they may introduce voltage drops and limit the rate of current change, impacting the overall system performance, particularly in high-power applications source inductance 125 should be kept as low as possible, typically in the range of a few micro Henries (pH) to minimize voltage drops and current ripple, while the source resistance 130 should be minimal, preferably a very low value to limit power losses; a high source resistance may lead to increased power dissipation, which may reduce efficiency.

Load 140, 145, and 145 may be but should not be limited to large industrial motors, heavy-duty HVAC systems, large commercial appliances, high-power machinery like CNC machines, large industrial ovens, and applications requiring significant power distribution across multiple phases, often seen in factories and large commercial buildings, and microgrids.

Control circuit 160 should preferably be capable of driving the transistors of half-bridge circuits 155, 156, 157, and 158 by varying the “on” and “off” times of the transistors to control the output voltage level and waveform. Control circuit 160 may drive half-bridge circuits 155, 156, 157, and 158 using a signal such as but not limited to pulse width modulation (PWM), pulse density modulation (PDM), sinusoidal PWM (SPWM), selective harmonic elimination (SHE), space vector modulation (SVM), and neutral point clamped (NPC) modulation. Control circuit 160 may utilize one or more control algorithms that may control the transistor driving, dead time, dead time compensation, and frequency and shape of phase outputs 120, 121, 122, and 123. Control circuit 160 may be implemented or performed with a general-purpose processor, a digital signal processor (DSP), an application-specific integrated circuit (ASIC), a field programmable gate array (FPGA), or other programmable logic device, discrete gate or transistor logic, discrete hardware components, or any combination thereof designed to perform the functions described herein.

Zero current or zero voltage switching, also referred to as soft switching, for high switching frequencies may be implemented using PDM with a simple binary signal that may reduce switching losses and associated electromagnetic interference (EMI) by creating smoother transitions between voltage and current levels, leading to a “softer” switching operation compared to traditional Pulse Width Modulation (PWM) techniques.

In theory, PDM zero-current/zero voltage switching, typically used in CMV elimination algorithms, removes nearly all common mode (CM) EMI, as represented below.

$${V}_{c m} = \frac{{v}_{1} + {v}_{2} + {v}_{3} + {v}_{5}}{4}$$

Unfortunately, the insertion of a dead time to avoid short circuits and damage interferes with the CMV elimination algorithm. Insertion of a dead time may lead to an unbalanced change in the output voltage on different half-bridge circuits 155, 156, 157, and 158. This unbalanced change in output voltage may produce spikes in CMV that may depend on the current polarity and whether the current is in the diode or transistor of half-bridge circuits 155, 156, 157, and 158 during switching events.

Dead time compensator 170 may be a circuit or an algorithm implemented separately or as part of control circuit 160. Dead time compensator 170 may be a delay in a switching event or an extension of an “on” time of a transistor. Dead time compensator 170 may make a decision at each switching event for each half-bridge circuit 155, 156, 157, and 158 based on the polarity of a current, Ix, and status of the transistor Sx. Dead time compensator 170 may determine whether the switching event should be delayed by extending the on-state of the switch or executed with no delay to the switching algorithm. On each half-bridge circuits 155, 156, 157, and 158 (inverter legs), the current may be flowing in a MOSFET, either positively, e.g., 1) the top switch is on (Sx=1) causing current to flow out of the inverter to load 140, 145, or 145, or negatively e.g. 2) the bottom switch is on (Sx=0) causing current to flow into the inverter from load 140, 145, or 145. In these cases, dead time compensator 170 should not affect the switching because the current should instantaneously transition to a MOSFET's capacitance and then a complementary diode. In all other cases dead time compensator 170 should delay the switching event.

In one embodiment, dead time compensator 170 may positively increment a delay in a switching event or an extension of an “on” time of a transistor beginning at 0 nanoseconds (ns). The maximum dead time compensator 170 range may be limited by phase outputs 120, 121, 122, and 123 voltage waveform and power quality tolerances and CMV tolerances; essentially, dead time compensator 170 range may be a balance between preventing short circuits, minimizing voltage distortion, and reducing CM EMI caused by the insertion of dead time.

Such a delay may be implemented by but should not be limited to a parameter within an algorithm, a time response circuit, or a timing circuit.

In an alternative embodiment, dead time compensator 170 may be a controller that variably adjusts the dead time or switching time delay based on a measured or sensed dv/dt or di/dt, a dv/dt or di/dt error rate, a measured or sensed CMV, or an unbalanced voltage or current. Such a controller may be but should not be limited to a proportional-integral-controller (PID), model predictive control (MPC), adaptive control, fuzzy logic controller, neural network control, sliding mode control, or fractional-order PID (FOPID)

Sensors 165 may be various voltage, current, hall, frequency, spectrum, LISN (Line Impedance Stabilization Network), TEM (Transverse Electromagnetic) cells, or timing sensors. Sensors 165 may provide raw, filtered, or represented measurements to control circuit 160 and or dead time compensator 170.

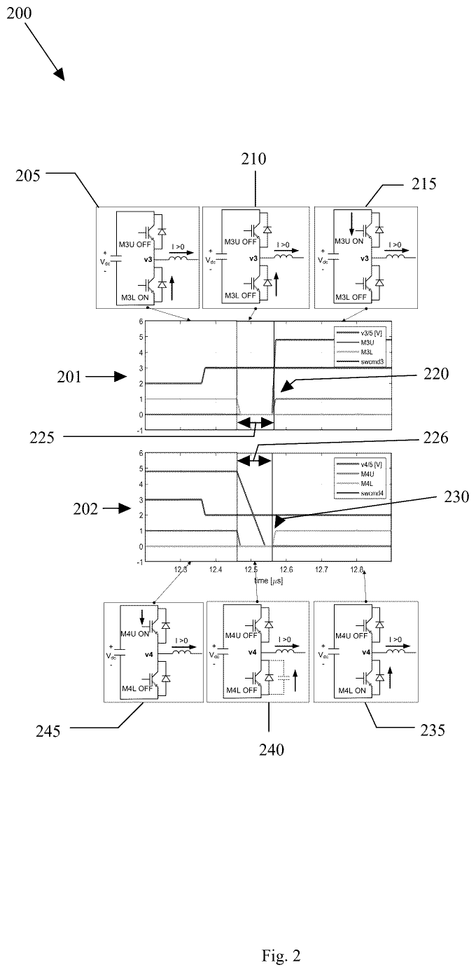

FIG. 2 is a graph illustrating common mode voltage during commutation of a four-legged inverter without dead time compensation. Inverter half-bridge circuits typically switch in pairs so that two top and two bottom switching transistors may be on at all times. For example, as shown in FIG. 2, commutation without dead time compensation 200 may be represented by a first half-bridge circuit represented by states 205, 210, and 215 (this may be equivalent to half-bridge circuit 156 of FIG. 1) while a second half-bridge circuit of a pair may be represented by states 245, 240, and 235 (this may be equivalent to half-bridge circuit 155 of FIG. 1). In states 205, 210, and 215, the current may be flowing in the diode, while in states 245, 240, and 235, the current may be flowing in the transistor. Plots 201 and 202 point out that the gate signals may occur at the same time for both half-bridge circuits, while the inverter pole voltages don't transition at the same time, leading to unwanted CMV spikes 220 and 230. As shown in FIG. 2, the dead time switching sequence 225 and 226 affects the desired CMV, leading to undesired CMV spikes 220 and 230.

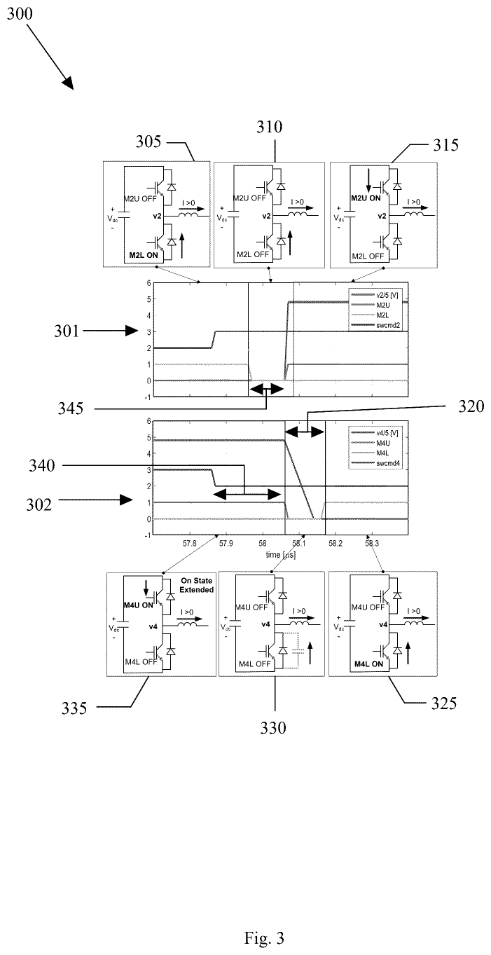

FIG. 3 is a graph illustrating common mode voltage during commutation of a four-legged inverter with dead time compensation. Inverter half-bridge circuits typically switch in pairs so that two top and two bottom switching transistors may be on at all times. For example, as shown in FIG. 3, commutation with dead time compensation 300 may be represented by a first half-bridge circuit represented by states 305, 310, and 315 (this may be equivalent to half-bridge circuit 157 of FIG. 1) while a second half-bridge circuit of a pair may be represented by states 335, 330, and 325 (this may be equivalent to half-bridge circuit 155 of FIG. 1). As shown in FIG. 3, the on-state of half-bridge circuit 157 of FIG. 1 may be extended 100 ns as compared to half-bridge circuit 155 so that the voltages v2 and v4 transition simultaneously. This result may be obtained with a modification of control circuit 160 to reduce the CMV produced by the inverter significantly. Since the dv/dt of the two half-bridge circuits in FIG. 3 may not be the same, perfect cancellation (e.g., soft switching or zero voltage switching) may not be possible but CMV (obtained by summing the four half-bridge circuit voltages) may be greatly reduced. In many events, the dv/dt for the two switching half-bridge circuits may be very similar, and almost no CMV exists during those events.

The following theoretical analysis clarifies the potential experience of dv/dt inequality. During a switching event where only two half-bridge circuits commutate, the CMV during the switching of two poles can be described by

$${v}_{cmswitching} = \frac{{v}_{H L} + {v}_{L H}}{4}$$

where VHL is the half-bridge circuit voltage that will switch from high to low, and VLH is the pole voltage that will switch from low to high. The other two half-bridge circuits do not switch, with one of them remaining high and the other remaining low. As the currents on each commutating inverter half-bridge circuit being different, with

$$- {i}_{p} < i < + {i}_{p}$$

resulting in different dv/dt and consequently different transition times on each switching pole, as described by

$$Δ t = \frac{C Δ v}{i}$$

where C=2Cₒₛₛ for two devices because the capacitances of the upper and lower devices are parallel when they are both off. Different dv/dt of each switching event mostly depends on the current in each half-bridge circuit at the moment of the switching event. CMV cancellation may work best when the dv/dt is similar for the switching half-bridge circuits.

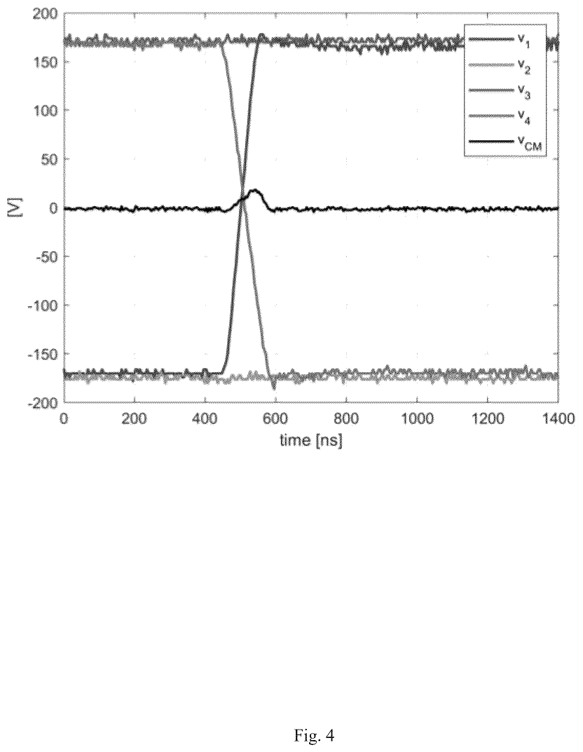

FIG. 4 is a graph representing a four-legged inverter's measured common mode voltage with zero dead time compensation. As shown in FIG. 4, CMV (Vcm) may be a voltage spike greater than zero volts that may occur at or near the zero-voltage switching time between multiple half-bridge circuits. In one embodiment, a dead time compensator can vary or delay the switching time algorithm, which may vary the voltage crossing of paired half-bridge circuits. This may lead to a non-zero CMV but may significantly reduce a voltage spike at or near the zero-voltage switching event.

In one embodiment, a four-legged, three-phase inverter may vary the switching of half-bridge circuits to balance the voltage over the three separate phases. In this situation, a dead time compensator may need to adjust the dead time compensation to proportionally delay a switching event in order to maintain a balanced voltage while still reducing CMV.

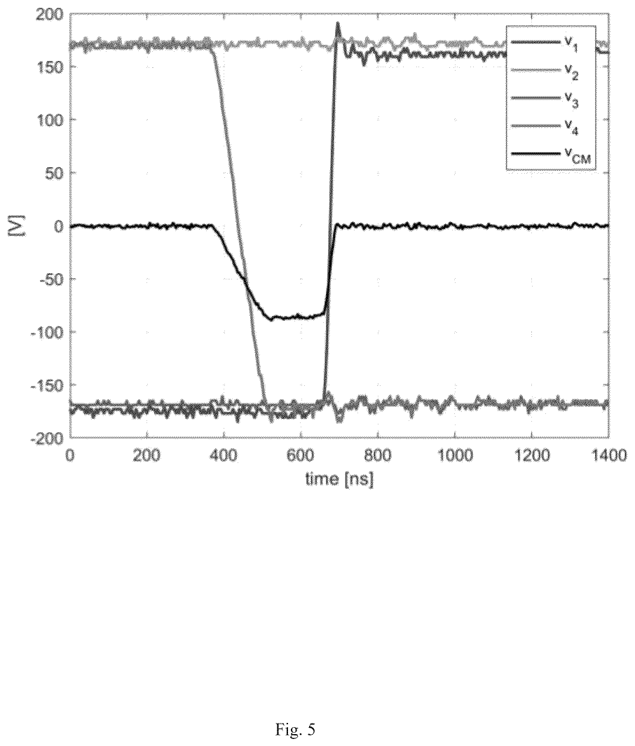

FIG. 5 is a graph representing the measured common mode voltage of a four-legged inverter having 100 ns of dead time compensation. As shown in FIG. 5, a dead-compensator introducing 100 ns of commutation delay may significantly reduce CMV voltage spikes that may occur at or near the zero-voltage switching time between multiple half-bridge circuits. Although 100 ns is shown in FIG. 5, this should not be interpreted as limiting as dead time compensation may be proportionally adjusted or designed using 0 to 400 ns delays.

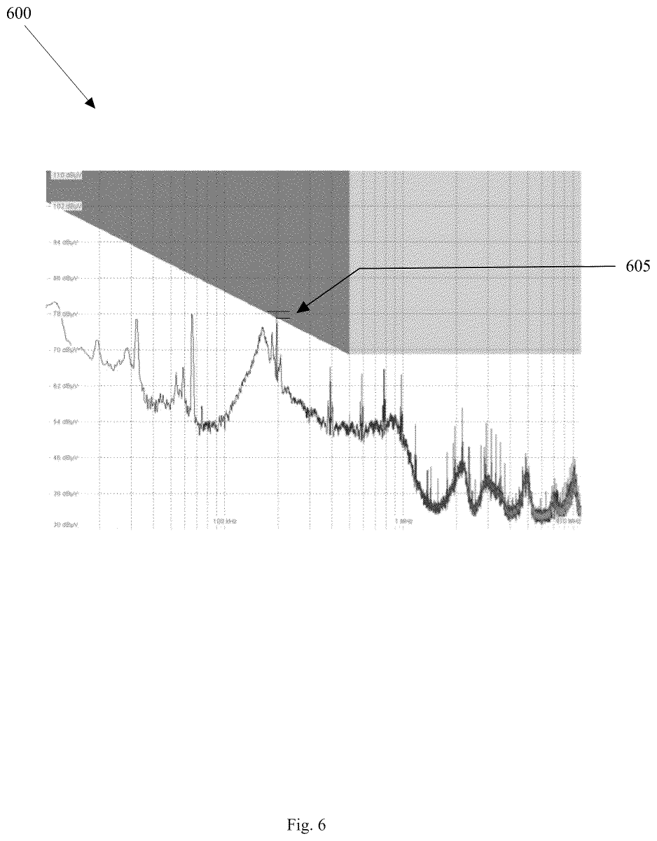

FIG. 6 is a spectral graph representing a four-legged inverter's measured common mode voltage with no additional dead time compensation. Spectral graph 600 may be overlayed with industry standards such as but not limited to CE102, with out-of-tolerance 605 parameters highlighting parameters that may need additional adjustment to meet industry standards.

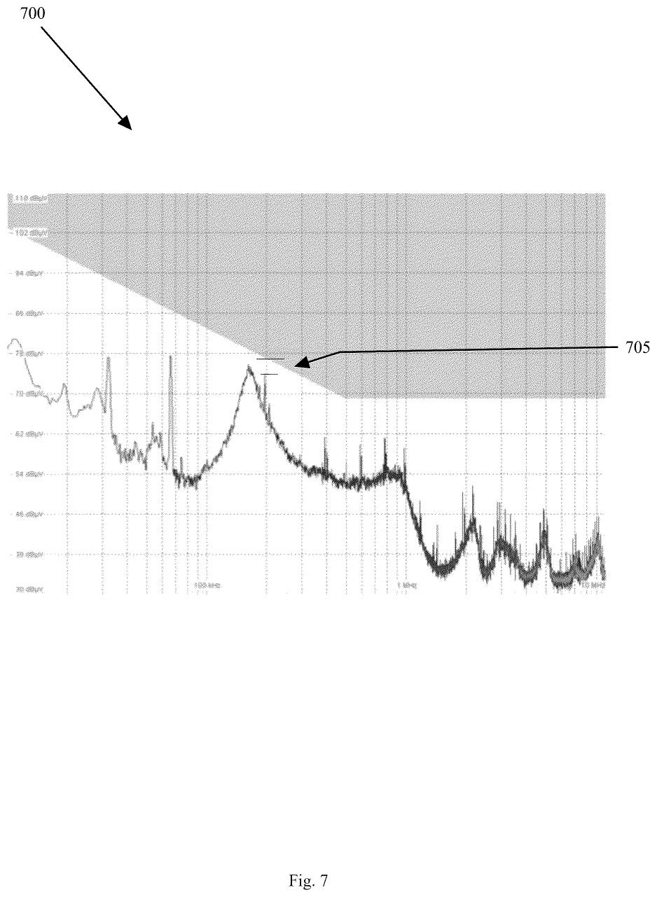

FIG. 7 is a spectral graph representing the measured common mode voltage of a four-legged inverter having dead time compensation. Spectral graph 700 may be overlayed with industry standards such as but not limited to CE102, showing all spectral components having a buffer 605 within a standard that may allow for fewer external filtering components.

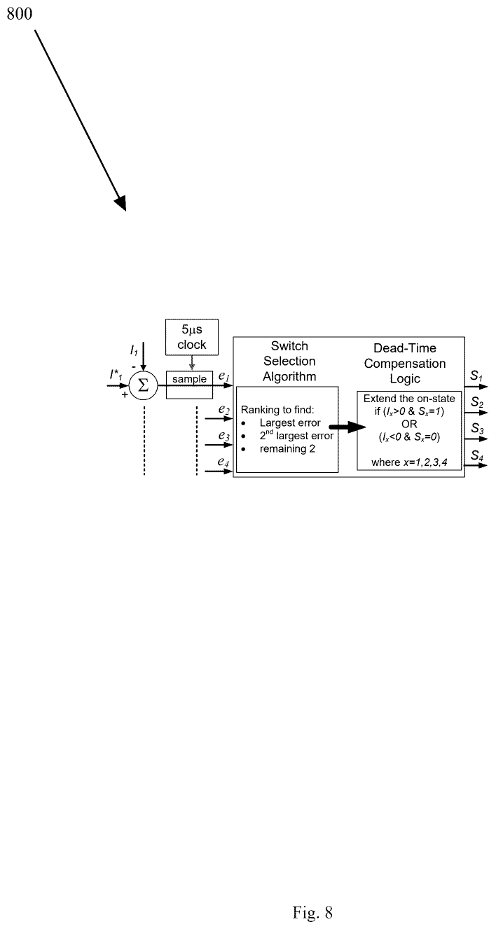

FIG. 8 is an illustration of one embodiment of a control system for a dead time compensator. Dead time compensator 800 may be a circuit or an algorithm implemented separately or as part of a control circuit. Dead time compensator 800 may utilize a delta modulation signal and rank any error, which may be represented by CMV. Dead time compensator 800 may utilize logic at every switching event to determine whether to extend the on-state or delay a switching event.

In one embodiment, dead time compensator 800 may extend the on-state if Ix>0 & Sx=1 or Ix<0 & Sx=0, where x=1, 2, 3, or 4, and S1, S2, S3, and S4 are outputs to a control unit or circuits that operate half-bridge circuits of an inverters.

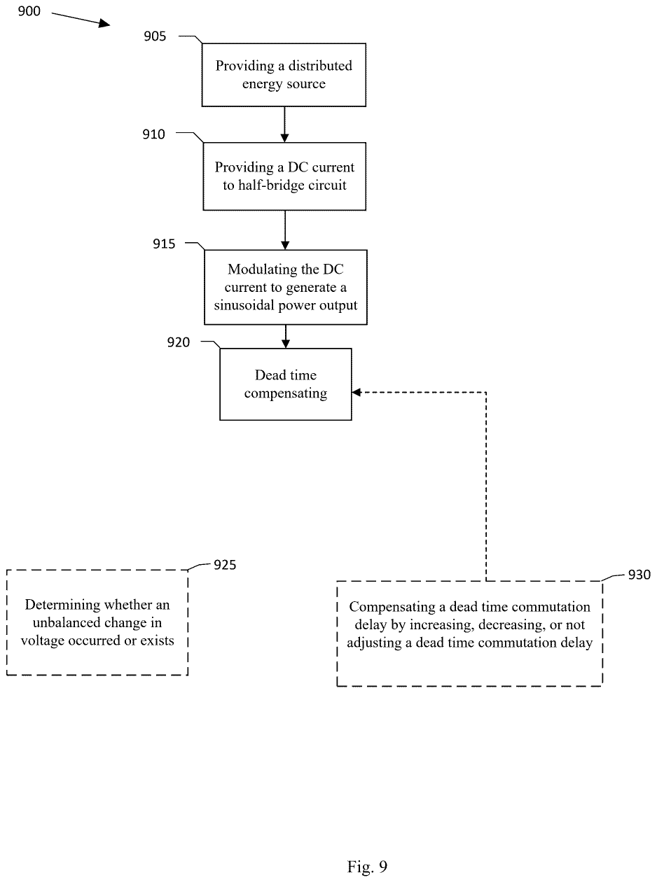

FIG. 9 is a process flow block diagram of one embodiment of a method of reducing EMI by controlling the dead time commutation in a four-legged inverter.

A method of reducing common mode EMI in a four-legged inverter, the method comprising: by a four-legged three-phase inverter 900:
providing a distributed energy source 905, wherein the distributed energy source is a direct current (DC) source; providing a DC current to four half-bridge circuits 910, modulating the DC current 915, by a control circuit pulse density modulating (PDM) to generate an alternating current (AC) sinusoidal electrical power output; and dead time compensating 920, by a control circuit, wherein the control circuit delays the commutation of the four half-bridge circuits.

One embodiment of the method 900 may further include compensating 930 a dead time commutation by increasing, decreasing, or not adjusting a delay in commutation. Dead time commutation delay may be based on a current polarity and the status of the multiple transistors.

One embodiment of method 900 may further include determining 925, whether an unbalanced change in voltage occurred or exists.

In one embodiment of method 900, the dead time commutation delay may be 0 nanoseconds (ns), 200 ns, 250 ns, 300 ns, 350 ns, or 400 ns.

In one embodiment of method 900, the dead time commutation delay may be 0 nanoseconds (ns) to 400 ns.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A reduced common mode voltage inverter comprising:
an energy source electrically coupled to multiple half-bridge circuits;
each of the multiple half-bridge circuits having an output and each output electrically coupled to one or more phase loads;
a control circuit electrically coupled to multiple transistors of each of the multiple half-bridge circuits; and
a dead time compensator to delay commutation of the multiple half-bridge circuits.

2. The inverter of claim 1, wherein a commutation dead time delay of the control circuit is equal to a dead time delay.

3. The inverter of claim 1, wherein a commutation dead time delay of the control circuit is between 0 nanoseconds (ns) to a maximum range based at least in part on a common mode voltage (CMV) tolerance and power output quality tolerance.

4. The inverter of claim 1, further comprising multiple sensors electrically coupled to the multiple transistors and the outputs of the multiple half-bridge circuits;
wherein the multiple sensors are configured to measure current and voltage of the multiple half-bridge circuits and the outputs;
wherein the control circuit determines whether an unbalanced change in a voltage or an unbalanced change in current exists between any of the multiple half-bridge circuits; and
wherein the control circuit determines whether to increase, decrease, or not adjust a commutation dead time delay.

5. The inverter of claim 4, wherein the commutation dead time delay of the control circuit is based at least in part on a polarity of a current and a status of the multiple transistors.

6. The inverter of claim 1, wherein the control circuit controls the multiple transistors by pulse density modulation.

7. The inverter of claim 1, further comprising four half-bridge circuits.

8. The inverter of claim 1, further comprising a four wire three phases output.

9. The inverter of claim 1, wherein the energy source is a direct current (DC) source, and the DC source is selected from the group of DC sources consisting of one or more of:
a battery, a solar cell, a fuel cell, a thermal conversion device, and a biomass.

10. A micro-grid common mode voltage reducing four-legged three phase inverter comprising:
a distributed energy source electrically coupled to four half-bridge circuits;
the four half-bridge circuits coupled to a four wire three phase output;
a control circuit electrically coupled to multiple transistors of the multiple half-bridge circuits, and controls the multiple transistors by pulse density modulation; and
a dead time compensator configured to delay commutation of the multiple half-bridge circuits.

11. The inverter of claim 10, further comprising multiple sensors electrically coupled to the multiple transistors and the three phase output;
wherein the sensors are configured to measure current and voltage of the multiple half-bridge circuits and the each of the three phase outputs;
wherein the control circuit determines whether an unbalanced change in a voltage or an unbalanced change in a current exists on any of the multiple half-bridge circuits; and
wherein the control circuit determines whether to increase, decrease, or not adjust a dead time commutation delay.

12. The inverter of claim 10, wherein the dead time commutation delay of the control circuit is based at least in part on a polarity of a current and a status of the multiple transistors.

13. The inverter of claim 10, wherein the dead time commutation delay of the control circuit is zero nanoseconds.

14. The inverter of claim 10, further comprising an LCL filter circuit at three of the half-bridge circuits and coupled to a four wire three phase output.

15. The inverter of claim 10, wherein the distributed energy source is a direct current (DC) source, and the DC source is selected from the group of DC sources consisting of one or more of: a battery, a solar cell, a fuel cells, a thermal conversion device, and a biomass.

16. A method of reducing common mode EMI in a four-legged inverter, the method comprising:
by a four-legged three phase inverter:
providing a distributed energy source, wherein the distributed energy source is a direct current (DC) source;
providing a DC current to four half-bridge circuits modulating the DC current, by a control circuit pulse density modulating (PDM) to generate an alternating current (AC) sinusoidal electrical power output; and
dead time compensating, by a control circuit, wherein the control circuit delays the commutation of the four half-bridge circuits.

17. The method of claim 16, wherein the dead time commutation delay is 0 nanoseconds (ns), 200 ns, 250 ns, 300 ns, 350 ns, or 400 ns.

18. The inverter of claim 16, wherein a commutation dead time delay is between 0 nanoseconds (ns) to a maximum range based at least in part on a common mode voltage (CMV) tolerance and power output quality tolerance.

19. The method of claim 16, further comprising: determining, by a control circuit, whether an unbalanced change in a voltage or a current exists on any of the multiple half-bridge circuits.

20. The method of claim 19, further comprising: compensating, by a control circuit, a dead time commutation delay;
wherein the control circuit determines whether to increase, decrease, or not adjust a dead time commutation delay; and
wherein the dead time commutation delay is based at least in part on a current polarity and a status of the multiple transistors.
